(19) United States
(12) Patent Application Publication
(10) Pub. No.: US 2019/0228268 A1
(43) Pub. Date: Jul. 25, 2019

(54) METHOD AND SYSTEM FOR CELL IMAGE SEGMENTATION USING MULTI-STAGE CONVOLUTIONAL NEURAL NETWORKS

(71) Applicant: KONICA MINOLTA LABORATORY U.S.A., INC., San Mateo, CA (US)

(72) Inventors: Yongmian ZHANG, Union City, CA (US); Jingwen ZHU, Foster City, CA (US)

(73) Assignee: KONICA MINOLTA LABORATORY U.S.A., INC., San Mateo, CA (US)

(21) Appl. No.: 16/315,560

(22) PCT Filed: Aug. 9, 2017
(86) PCT No.: PCT/US17/46173

§ 371 Date: Jan. 4, 2019

Related U.S. Application Data
(60) Provisional application No. 62/394,684, filed on Sep. 14, 2016.

(51) Int. Cl. G06K 9/62; G06N 3/04; G06N 3/08

(52) U.S. Cl. CPC G06K 9/6262; G06K 9/6256; G06N 3/08; G06N 3/0454

(57) ABSTRACT

An artificial neural network system for image classification, including multiple independent individual convolutional neural networks (CNNs) connected in multiple stages, each CNN configured to process an input image to calculate a pixelwise classification. The output of an earlier stage CNN, which is a class score image having identical height and width as its input image and a depth of N representing the probabilities of each pixel of the input image belonging to each of N classes, is input into the next stage CNN as input image. When training the network system, the first stage CNN is trained using first training images and corresponding label data; then second training images are forward propagated by the trained first stage CNN to generate corresponding class score images, which are used along with label data corresponding to the second training images to train the second stage CNN.

### BACKGROUND OF THE INVENTION

### Field of the Invention

This invention relates to artificial neural network technology, and in particular, it relates to an improved convolutional neural network (CNN).

### Description of Related Art

Artificial neural networks are used in various fields such as machine leaning, and can perform a wide range of tasks such as computer vision, speech recognition, etc. An artificial neural network is formed of interconnected layers of nodes (neurons), where each neuron has an activation function which converts the weighted input from other neurons connected with it into its output (activation). In a learning process, training data are fed into to the artificial neural network and the adaptive weights of the interconnections are updated through the leaning process. After learning, data can be inputted to the network to generate results (referred to as prediction).

A convolutional neural network (CNN) is a type of feed-forward artificial neural networks; it is useful particularly in image recognition. Inspired by the structure of the animal visual cortex, a characteristic of CNNs is that each neuron in a convolutional layer is only connected to a relatively small number of neurons of the previous layer. A CNN typically includes one or more convolutional layers, pooling layers, ReLU (Rectified Linear Unit) layers, fully connected layers, and loss layers. In a convolutional layer, the core building block of CNNs, each neuron computes a dot product of a 3D filter (also referred to as kernel) with a small region of neurons of the previous layer (referred to as the receptive field); in other words, the filter is convolved across the previous layer to generate an activation map. This contributes to the translational invariance of CNNs. In addition to a height and a width, each convolutional layer has a depth, corresponding to the number of filters in the layer, each filter producing an activation map (referred to as a slice of the convolutional layer). A pooling layer performs pooling, a form of down-sampling, by pooling a group of neurons of the previous layer into one neuron of the pooling layer. A widely used pooling method is max pooling, i.e. taking the maximum value of each input group of neurons as the pooled value; another pooling method is average pooling, i.e. taking the average of each input group of neurons as the pooled value. The general characteristics, architecture, configuration, training methods, etc. of CNNs are well described in the literature. Various specific CNNs models have been described as well.

In quantitative analysis of pathological images, quantification is usually carried out on single cells before grading them. However, the cell on an image captured by a microscope may vary in size, shape, and potentially overlap each other. Clusters of cell are frequently observed. It is critical to segment overlapping cells in pathological analysis. In addition, cell images may have large variations in image stain, as well as inhomogeneous cell regions (e.g., the interior of cells may not be a uniform color or grey shade, or may even have holes etc.).

In order to achieve high classification accuracy, a common approach is to use much deeper (larger) networks (i.e. networks with more layers). This will cause an exponential increase of network parameters as a function of the number of layers and hence the required computer memory. Moreover, a larger dataset will be required for training the networks. In cell image segmentation tasks, however, the available training image dataset is usually very small, but very high detection accuracy is required.

P. Viola et al., Detecting pedestrians using patterns of motion and appearance. IJCV, 63(2):153-161, 2005, describes cascades Adaboost classifiers. This is one of the earliest works of using multi-stage classifiers for face detection. With a cascaded structure, each classifier processes a different subset of data. These classifiers are sequentially trained without joint optimization.

W. Ouyang et al., DeepID-Net: multi-stage and deformable deep convolutional neural networks for object detection, IEEE Conference on Computer Vision and Pattern Recognition (CVPR), 2015, mentions the notion of multi-stage training. In their model structure, multistage training is performed at the last two fully connected layers. Each stage handles samples at a different difficulty level. For example, the first stage handles easy samples, the second stage handles more difficult samples, and so on.

### SUMMARY

Embodiments of the present invention provides a multi-stage convolutional neural network (CNN) system for segmenting cells with varying sizes and shapes by using multiple consecutive networks, instead of a deeper network.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides an artificial neural network system implemented on a computer for image classification, which includes: a first stage convolutional neural network (CNN), for receiving an input image and classifying each pixel of the input image among N classes, N being a natural number greater than or equal to two, to generate a first stage class score image, the first stage class score image having a height and a width identical to those of the input image and having a depth equal to N, a pixel value of each pixel of the first stage class score image being a vector of size N representing first stage preliminary probabilities of a corresponding pixel in the input image belonging to the corresponding one of N classes; and a second stage CNN, coupled to the first stage CNN, for receiving the first stage class score image and classifying each pixel of the first stage class score image among N classes, to generate a second stage class score image, the second stage class score image having a height and a width identical to those of the input image and having a depth equal to N, a pixel value of each pixel of the second stage class score image being a vector of size N representing second stage preliminary probabilities of a corresponding pixel in the input image belonging to the corresponding classes, wherein each of the first stage CNN and the second stage CNN has a plurality of layers of neurons stacked sequentially, including at least a plurality of convolutional layers and a plurality of pooling layers, each convolutional layer performing convolution operations to convolve a number of filters across its previous layer, each pooling layer performing pooling operations on its previous layer.

In another aspect, the present invention provides an image classification method using an artificial neural network system implemented on a computer, which includes: providing a first stage convolutional neural network (CNN) and a second stage CNN, each of the first stage CNN and the second stage CNN having a plurality of layers of neurons stacked sequentially, including at least a plurality of convolutional layers and a plurality of pooling layers, each convolutional layer performing convolution operations to convolve a number of filters across its previous layer, each pooling layer performing pooling operations on its previous layer; inputting an input image into the first stage CNN; using the first stage CNN to classify each pixel of the input image among N classes, N being a natural number greater than or equal to two, to generate a first stage class score image, the first stage class score image having a height and a width identical to those of the input image and having a depth equal to N, a pixel value of each pixel of the first stage class score image being a vector of size N representing first stage preliminary probabilities of a corresponding pixel in the input image belonging to the corresponding one of N classes; inputting the first stage class score image into the second stage CNN; and using the second stage CNN to classify each pixel of the first stage class score image among N classes, to generate a second stage class score image, the second stage class score image having a height and a width identical to those of the input image and having a depth equal to N, a pixel value of each pixel of the second stage class score image being a vector of size N representing second stage preliminary probabilities of a corresponding pixel in the input image belonging to the corresponding classes.

In another aspect, the present invention provides a method of training an artificial neural network system for image classification, the artificial neural network system being implemented on a computer and including a first stage convolutional neural network (CNN) and a second stage CNN, each of the first stage CNN and the second stage CNN having a plurality of layers of neurons stacked sequentially, including at least a plurality of convolutional layers and a plurality of pooling layers, each convolutional layer performing convolution operations to convolve a number of filters across its previous layer, each pooling layer performing pooling operations on its previous layer, the training method including: (a) training the first stage CNN using a first plurality of training images and first corresponding label data, wherein the label data corresponding to each of the first plurality of training image has a height and a weight equal to those of the corresponding training image and a pixel value of each pixel of the label data represents a desired classification result for a corresponding pixel of the corresponding training image, the desired classification being one of N classes, the training being conducted for M1 iterations to obtain a set of parameters for the first stage CNN; (b) using the first stage CNN with the parameters obtained in step (a), performing forward propagation on each of a second plurality of training images, to generate a corresponding plurality of first stage class score images, each first stage class score image having a height and a width identical to those of the corresponding training image and having a depth equal to N, a pixel value of each pixel of the first stage class score image being a vector of size N representing first stage preliminary probabilities of a corresponding pixel in the corresponding training image belonging to the corresponding one of N classes; (c) training the second stage CNN using the plurality of first stage class score images and second label data that correspond to the second plurality of training images, wherein the second label data corresponding to each of the second plurality of training image has a height and a weight equal to those of the corresponding training image and a pixel value of each pixel of the label data represents a desired classification result for a corresponding pixel of the corresponding training image, the desired classification being one of N classes, the training being conducted for M2 iterations to obtain a set of parameters for the second stage CNN.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates the architecture of a multi-stage CNN system according to embodiments of the present invention.

FIG. 2 schematically illustrates the architecture of an exemplary multi-stage CNN system according to an embodiment of the present invention, where each CNN is based on a VGG network model.

FIGS. 3(a) and 3(b) schematically illustrate two methods of training the multi-stage CNN system of FIG. 1 according to embodiments of the present invention.

FIGS. 4(a), 4(b) and 5 show examples of cell image classification results obtained by a multi-stage CNN system constructed and trained according to an embodiment of the present invention.

### DETAILED DESCRIPTION OF PREFERRED EMBODIMENTS

Embodiments of the present invention provides a multi-stage convolutional neural network (CNN) system which includes multiple individual CNNs arranged in series, where the prediction output of an earlier stage CNN is inputted to the next stage CNN as input image. The multiple CNNs are otherwise independent of each other. The system is designed in particular to handle cell images segmentation with the goal of increasing accuracy in particular in edge detection. A two-stage CNN system is described in the examples below, but the system may have other numbers of stages.

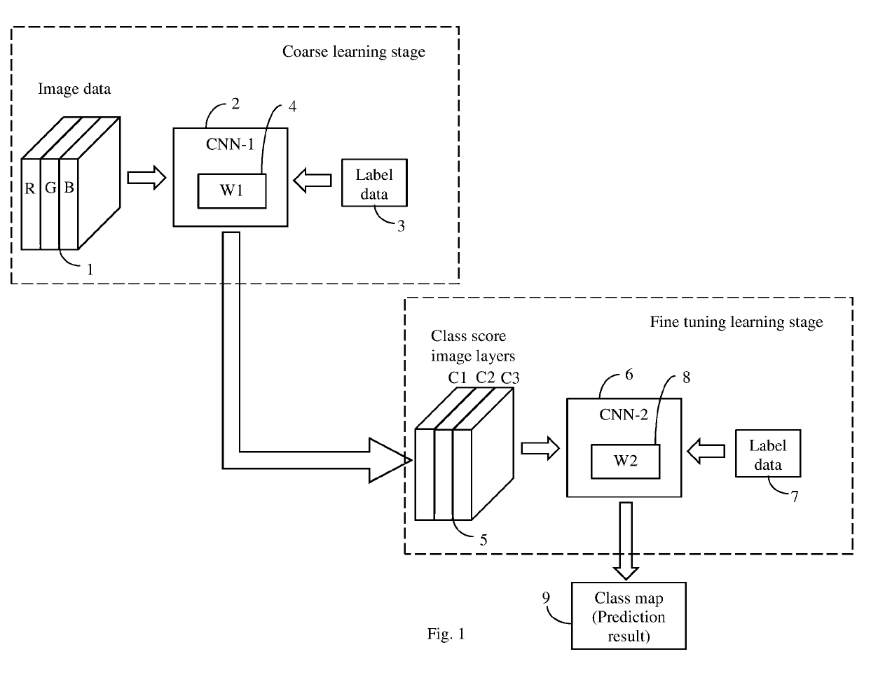

FIG. 1 schematically illustrates the architecture of a two-stage CNN system according to embodiments of the present invention, including a first stage convolutional neural network 2 (“CNN-1”) and a second stage convolutional neural network 6 (“CNN-2”). For convenience, in this two-stage system, the first stage is referred to as the “coarse learning” stage and the second stage is referred to as the “fine tuning learning” stage.

In the training process, the first stage convolutional neural network 2 (“CNN-1”) receives training image data 1 as input. In this embodiment, the training image data 1 has three color channels, namely red, green and blue channels. The first stage network CNN-1 also receives label data 3 (i.e. the desired classification result) corresponding to the training image data 1. The label data corresponding to each training image is a map having the same height and width as the training image where each pixel has a pixel value representing the desired classification result for the corresponding pixel of the training image. Supervised learning is conducted using the training images 1 and corresponding label data 3 to learn the weights W1 4 of the first stage network CNN-1. Generally speaking, a supervised learning algorithm processes labeled training data and produces network parameters that minimize a loss function on the training data through multiple iterations. Any suitable training algorithm may be used to train the first stage CNN. The first stage network CNN-1 is a convolutional neural network which includes a number of distinct types of layers, including convolutional layers, pooling layers and rectified linear unit (ReLU) layers, etc. The parameters of a convolutional layer consist of a set of learnable filters and each filter is convolved across the width and height of the input volume and producing a 2-dimensional activation map of that filter. The pooling layer is to reduce the dimensions after convolution, and also to provide a form of translation invariance. The rectified linear unit layer is to increase the nonlinear properties of the decision function.

The prediction result generated by the trained first stage network CNN-1, constructed from an input image through forward propagation, is a class score image 5 (referred to as a coarse class score image in the two-stage system), which is fed into the second stage convolutional neural network 6 (“CNN-2”) as input. The classification performed by the first stage network CNN-1 is a pixelwise classification, i.e., each pixel of the input image is classified. In this embodiment, three classes are defined, namely cells, edge (boundary), and background. For each pixel, the first stage network CNN-1 generates the probabilities of the pixel belonging to each of the three classes. Thus, the class score image 5 output by the first stage network CNN-1 has a height and a width identical to those of the input image 1, and a depth that equals to the number of classes defined in the classification. Each depth layer (channel) of the class score image 5 corresponds to a class, denoted C1, C2 and C3 in FIG. 1. The pixel value of each pixel of the class score image 5 is a vector that represents the probabilities of the corresponding image pixel of the input image belonging to the corresponding classes C1, C2, and C3.

In the fine-tuning learning stage, the second stage network CNN-2 receives the class score images 5 as input images to the network, as well as label data 7. The label data 7 is the same as the label data 3 used in the coarse learning stage, i.e., the label data for the original input images 1. Supervised learning is conducted using the input class score images 5 and corresponding label data 7 to learn the weights W2 8 of the second stage network CNN-2.

Like the first stage network CNN-1, the second stage network CNN-2 is a convolutional neural network which includes a number of distinct types of layers, including convolutional layers, pooling layers and rectified linear unit (ReLU) layers, etc. The first stage network CNN-1 and the second stage network CNN-2 are independent of each other in that no intermediate results from the first stage CNN is used by the second stage CNN or vice versa, and that the weights of the two networks are independent of each other. When the multi-stage CNN system has more than two stages, all stages are independent of one another.

The first and second stage networks (CNN-1 and CNN-2) may have the same or similar model structures in terms of the numbers and arrangements of the layers and the size of the layers, or different model structures. In one embodiment, the first and second stage networks (CNN-1 and CNN-2) have different model structures and the first stage network CNN-1 has more layers than the second stage network CNN-2. The independence of the different stage CNNs allows for more flexibility in designing each network.

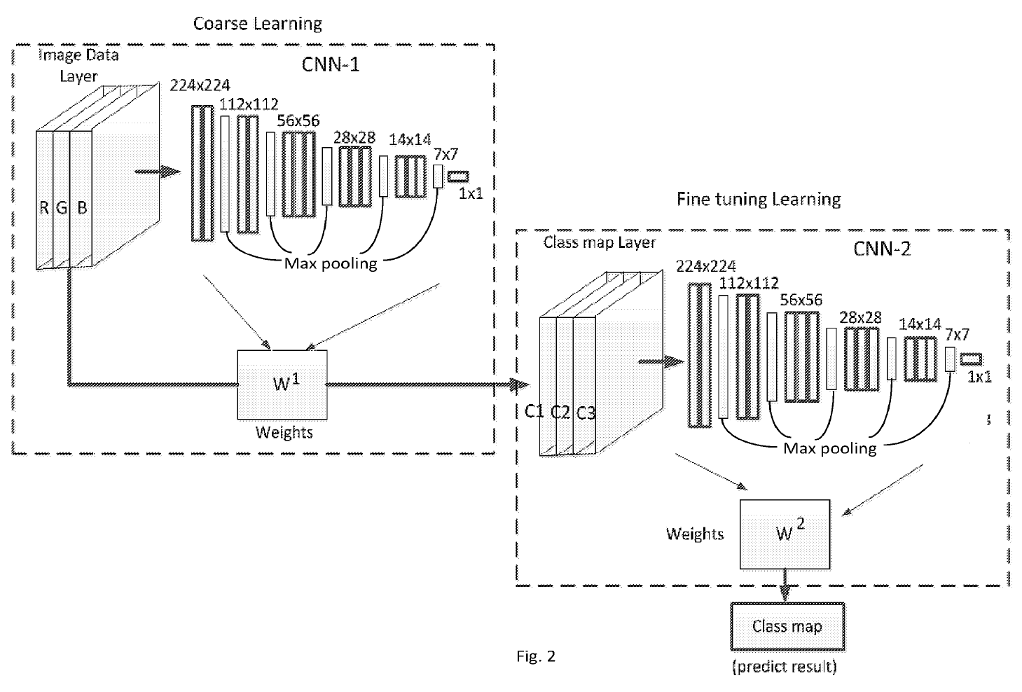

FIG. 2 schematically illustrates the architecture of an exemplary two-stage CNN system according to an embodiment of the present invention. The two networks CNN-1 and CNN-2 have identical model structures, where each CNN is based on a VGG 16-layer network model with modifications. The modifications include removing the last few layers of the VGG model. The VGG model, including its architecture and configuration, and training and prediction processes, are described in K. Simonyan et al., Very Deep Convolutional Networks For Large-Scale Image Recognition, ICLR 2015 (“K. Simonyan et al. 2015”).

In the specific example shown in FIG. 2, each CNN includes the following layers in order: two convolutional layers (224×224×64), max pooling layer (112×112×64), two convolutional layers (112×112×128), max pooling layer (56×56×128), three convolutional layers (56×56×256), max pooling layer (28×28×256), three convolutional layers (28×28×512), max pooling layer (14×14×512), three convolutional layers (14×14×512), max pooling layer (7×7×512), and finally a convolutional and softmax layer (1×1×3) (the depth 3 of this layer corresponds to the 3 output classes). In a preferred embodiment, the size of the convolution filter in all convolutional layers is 3×3. This example is adopted from K. Simonyan et al. 2015, Table 1.

Note that in the multi-stage CNN system shown in FIG. 1, the input to the second stage network CNN-2 (and subsequent stages if present), i.e. the coarse class score image 5, is not an actual cell image and its multiple layers (channels) do not represent the three RGB color channels. The coarse class score image 5 is a core building block of the multi-stage CNN system as it is the link between one stage and the next stage. Moreover, as will be explained in more detail later, the training of the first stage network is such that the class score images generated by the first stage preserve useful information about the input image and are thus particularly suited for the fine tuning learning.

After the multi-stage CNN system is trained, it is used to analyze input images, referred to as the prediction process. FIG. 1 also represents the prediction process, although label data 3 and 7 will not be used. In the prediction process, the input image 1 to be analyzed is fed into the trained first stage network CNN-1, and the coarse classification result (coarse class score image) 5 is generated. As described above, the class score image 5 has a height and a width identical to those of the input image 1, and has a number of layers each corresponding to one of the classes of the classification, denoted C1, C2 and C3 in this example. Each class score image layer is an image where the pixel value represents the probability of the corresponding pixel of the input image 1 belonging to that particular class. The coarse class score image 5 is fed into the trained second stage network CNN-2 as input image, to generate a final class score image (also referred to as class map) 9. Like the coarse class score image 5, the final class score image 9 has a height and a width identical to those of the input image 1, and has a number of layers each corresponding to one of the classes of the classification, where each pixel value in a final class score image layer represents the final probability of the corresponding pixel of the input image 1 belonging to a particular class. It can be seen that the final prediction result 9 is produced using the learned weights of both networks CNN-1 and CNN-2 .

For a system including three or more stages, the output image of the first, second, etc. stage CNNs may be referred to as “first stage class score image”, “second stage class score image”, etc. representing first stage preliminary probabilities, second stage preliminary probabilities, etc. of the image classification, and the output of the final stage may be referred to as the “final stage class score image” representing the final probabilities of the image classification.

The training for the first stage and second stage networks CNN-1 and CNN-2 is designed so that the coarse learning stage learns the weights W1 of CNN-1 while preserving useful features of the images as much as possible so that the cell boundary information is less prone to be lost in the fine learning stage, while the fine-tuning learning stage learns the weights W2 of CNN-2 by refining the shape of the cells. This may be achieved by controlling the number of iterations for each training stage.

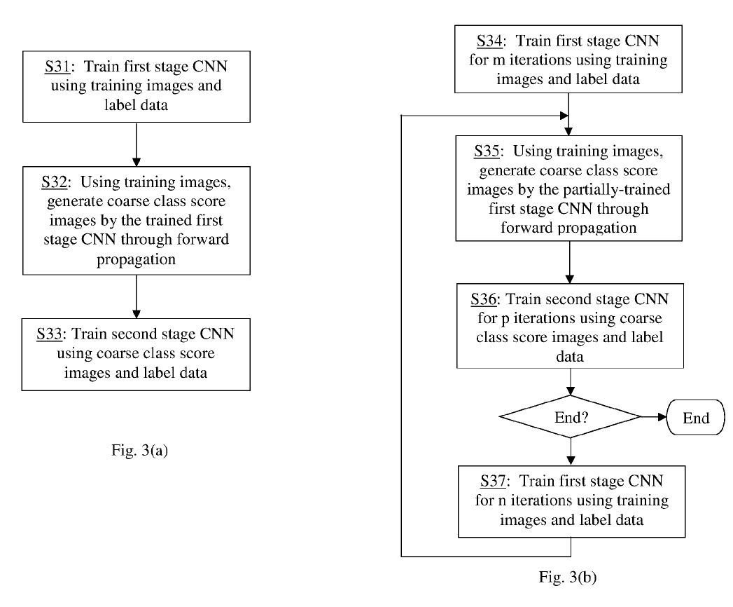

In one embodiment (see FIG. 3(a)), the first stage network CNN-1 is trained first, using training images 1 and label data 3, through a first number of iterations to learn the first stage weights W1 (step S31). The first number of iterations is deliberately fewer than would otherwise be optimum, e.g. fewer than the number that would be optimum if the same CNN network model is used as a single-stage network by itself. In one particular example, the first stage network CNN-1 having the configuration shown in FIG. 2 was trained for 10,000 iterations. As a result, some “noise” will remain in the class score images generated by the trained first stage network CNN-1, which will effectively preserve useful features, in particular edge features, in the images.

Then, using the training images 1, corresponding coarse class score images 5 are generated by the trained first stage network CNN-1 using forward propagation (step S32). Using the coarse class score images 5 and corresponding label data 7, the second stage network CNN-2 is trained through a second number of iterations (step S33). The second number of iterations is not deliberately fewer than would otherwise be optimum. In the example where the first stage network CNN-1 was trained for 10,000 iterations, the second stage network CNN-2 was trained for 20,000 iterations. The numbers of iterations used in the first stage training (coarse learning) and second stage training (fine-tuning learning) may be different from the above example, but preferably, the number of iterations in the first stage is fewer than the number of iterations in the second stage. This training scheme may be referred to as sequential training.

In another embodiment (see FIG. 3(b)), training is conducted in a different sequence than the embodiment of FIG. 3(a). The first stage network CNN-1 is trained for m iterations until the coarse learning has a well convergence (step S34). Then, coarse class score images 5 are generated by the partially trained first stage network CNN-1 using the weights learned so far (step S35), and fed into the second stage network CNN-2 to train it for p iterations (step S36). Then, training is continued for the first stage network CNN-1 for another n iterations (step S37). Steps S35 to S37 are repeated, where in each repetition the first stages weights learned up to that point are used to generate the coarse class score images for training the second stage. This training scheme may be referred to as concurrent training.

The resulting network parameters learned using the sequential and concurrent training methods of FIGS. 3(a) and 3(b) are expected to be approximately the same.

For a network system including three or more CNN, the first two may be trained as described above, and then second stage class score images may be generated from input images using the trained first and second stage CNNs by forward propagation, and the third CNN may be trained using second stage class score images and original label data for the input images.

It can be shown that the multi-stage CNN system and its training scheme described above can ensure that the overall loss function can converge as in an ordinary single-stage convolutional neural network. As a result, the trained parameters from the multi-stage CNN system are optimized. This can be proved as follows. A general loss function can be written as (Equation (1)):

L=g(Wx+b−Y)

where W, b and Y are the trained weights, trained bias, and label, respectively, and x is an input. Because the first and second stage networks CNN-1 and CNN-2 are independent of each other, Equation (1) can be rewritten as (Equation (2)):

L=g(W¹x¹+b¹−Y)+g(W²x²+b²−Y)

where x¹ and x² are the training image data and calculated the class score images, respectively. W¹, b¹ are the learned parameters of the first stage network CNN-1, and W², b² are the learned parameters of the second stage network CNN-2. The label Y is the same for both stages of learning. Let

L¹=g(W¹x¹+b¹−Y)

L²=g(W²x²+b²−Y)

where L¹, L² are the loss function for the first and second stage networks CNN-1 and CNN-2, respectively; they can be optimized by gradient descent, which has been proven in ordinary single-stage neural networks. Based on dynamic optimization theory, the loss function L is jointly optimized if L¹ and L² are optimized individually, which means that the trained parameters W¹, b¹ and W², b² are optimized.

In embodiments of the present invention, for cell image prediction, the two networks CNN-1 and CNN-2 each uses a softmax function to generate the probability map for each class, that is,

p(Y=i|X,W,b)=Softmaxᵢ(Wx+b)

where i denotes a specific class, and W and b are the trained weights and bias. In the first stage (coarse leaning), a class probability map may be obtained (Equation (3)):

$${p}^{1} ( Y = i \vert x , {W}^{1} , {b}^{1} ) = \frac{{e}^{( {W}_{i}^{1} x + {b}_{i}^{1} )}}{{\sum }_{j} {e}^{( {W}_{j}^{1} x + {b}_{j}^{1} )}}$$

In cell detection applications, i=1, 2, 3 denotes background class, cell class and boundary class, respectively. p¹(Y=1|*), p¹(Y=2|*), p¹(Y=3|*) can be normalized to a 3-channel image, which forms a class score image, where * denotes {x,W¹, b¹}. In addition, if the number of classes is more than 3, i.e., i=1, 2, . . . , n|n>3, p¹ (Y=i|*) can be normalized to an n-channels image. Because the class score image is the input of the second stage or fine-tuning learning, the class probability map for the fine learning stage can be written as

$${p}^{2} ( Y = i \vert x , {W}^{2} , {b}^{2} ) = \frac{{e}^{( {W}_{i}^{2} {p}^{1} + {b}_{i}^{2} )}}{{\sum }_{j} {e}^{( {W}_{j}^{2} {p}^{1} + {b}_{j}^{2} )}}$$

where p¹ denotes the class score image normalized from the output of Equation (3). The above equation is still a form of softmax function and its output will be the final class probability map. This proof can be extended to more than two stages.

Thus, the architecture of the multi-stage CNN system allows optimization of the total loss function by jointly optimizing the individual loss functions of the multiple networks. This also means that the architecture can be extended to add more down-stream stages without having to re-train networks of the existing stages.

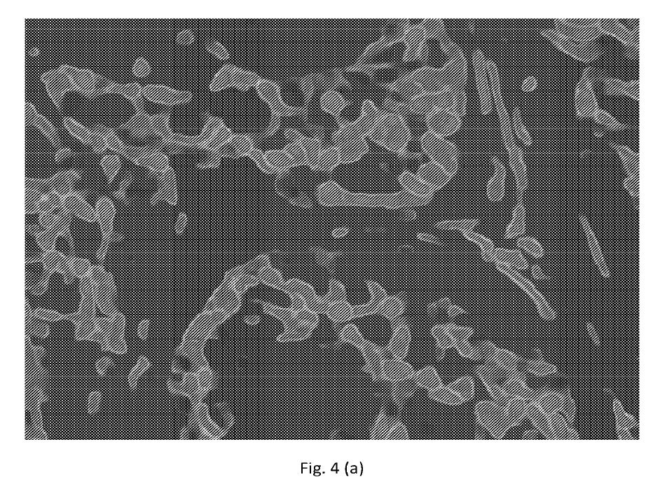

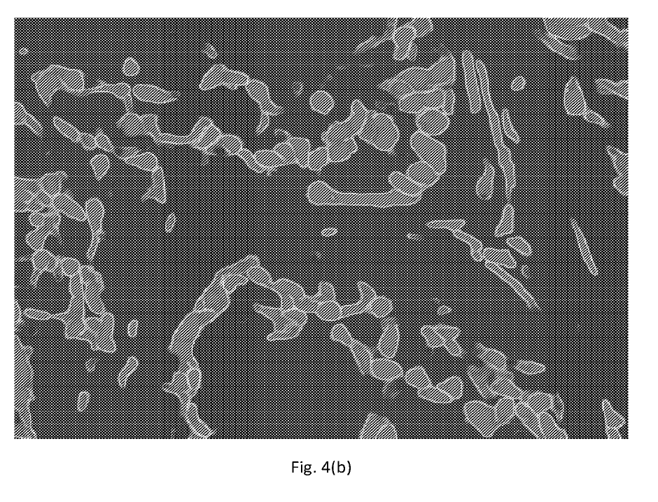

An example of cell image classification results using the two-stage CNN system of FIG. 2 is shown in FIGS. 4(a) and 4(b). FIG. 4(a) illustrates a coarse class score image generated by the trained first stage network CNN-1; FIG. 4(b) illustrates a corresponding final segmentation result (class prediction map) generated by the trained second stage. In FIGS. 4(a) and 4(b), the background, edge, and cell probability values are show in the images with the blue, green and red channels, respectively, for convenient visualization. It can be seen that, in the coarse class score image generated by the first stage (FIG. 4(a)), the boundary information is preserved as much as possible, such that many pixels that not actually boundary pixels were classified as boundaries. In the final class score image generated by the second stage (FIG. 4(b)), the cell boundaries and shapes are clearly detected. Further, some noises present in the coarse class score image (FIG. 4(a)) are no longer present in the final class score image (FIG. 4(b)).

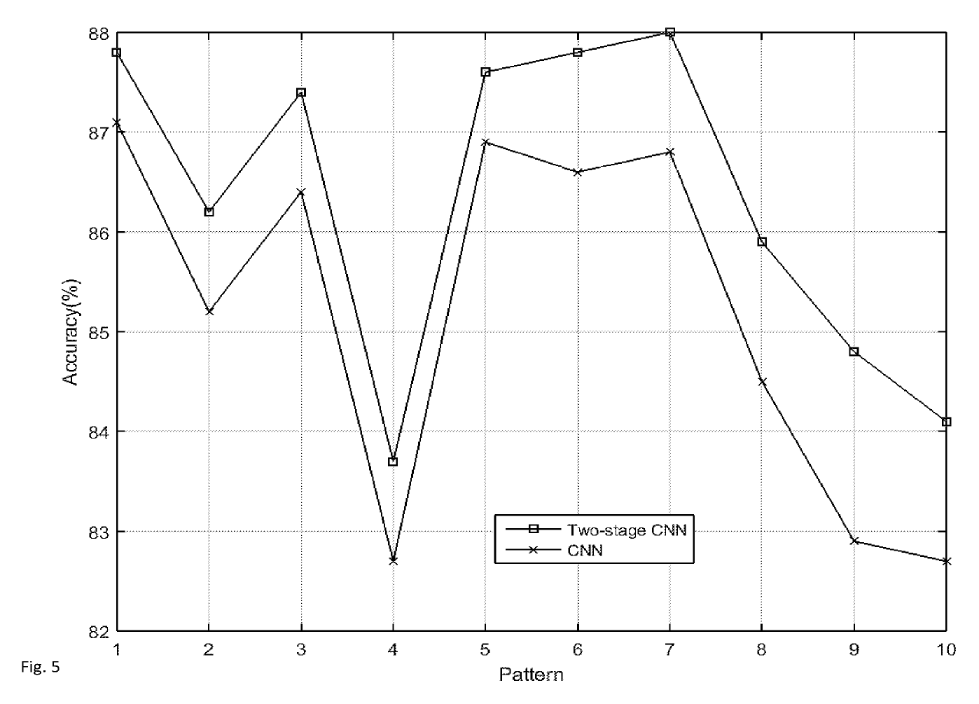

Further, the two-stage CNN system of FIG. 2 was evaluated using ten data sets of cell images. Label data for the images were used to evaluate accuracy of the prediction results. The ten data sets contained 100 cell images which were divided into ten sets based on image intensity, the density of cell overlapping, etc. so they have various degrees of difficulty. The results from the two-stage CNN system shown in FIG. 2 are compared to the results from a single-stage CNN having the same network model as each individual stage of the two-stage CNN system (the single stage CNN was trained for 200000 iterations). The comparison is shown in FIG. 5. It can be seen that for all data sets, the two-stage CNN system gave significantly improved accuracy of cell image segmentation.

To summarize, in embodiments of the present invention, a multi-stage convolutional neural network system, instead of a single deeper network, is employed to improve accuracy of cell image segmentation. This technology can achieve high accuracy in cell detection even when only a relatively small training dataset is available. In a two-stage system, two CNNs are used, one for coarse learning and another for the fine-tuned learning. The first stage is designed to preserve useful features of the images as much as possible so that the cell boundary information is less prone to be lost in the fine learning stage. In the fine-tuning learning stage, the learning using coarse class score images is still supervised by label data so that very accurate and fine-tuned boundaries can be obtained. As a result, cell segmentation using learned weights W1 and W2 can more accurately detect boundary and cell shape.

The multi-stage CNN system according to embodiments of the present invention has the following additional advantages: As compared to using a single deeper network, by using two smaller networks, the network training is much easier, the weights of the two individual networks can be optimized more easily, the network parameters are reduced dramatically, the computer memory can be reduced dramatically, and a relative small training dataset can be used while still obtain network parameters that achieve high segmentation accuracy. Further, the two stage training procedure helps to avoid overfitting as compared to using a single deeper network. Overall, the multi-stage system and method of the present embodiments increase the accuracy of cell boundary extraction, so the cell shape property is well preserved, which is an important benefit for pathologic analysis.

The multi-stage CNN system described above can be implemented on a computer system which includes processors and memories storing computer executable programs. For example, it may be implemented on a GPU (graphics processing unit) cluster machine. The design of the network model architecture facilities GPU parallelization.

It will be apparent to those skilled in the art that various modification and variations can be made in the multi-stage CNN system and related method of the present invention without departing from the spirit or scope of the invention. Thus, it is intended that the present invention cover modifications and variations that come within the scope of the appended claims and their equivalents.

What is claimed is:

1. An artificial neural network system implemented on a computer for image classification, comprising:
a first stage convolutional neural network (CNN), for receiving an input image and classifying each pixel of the input image among N classes, N being a natural number greater than or equal to two, to generate a first stage class score image, the first stage class score image having a height and a width identical to those of the input image and having a depth equal to N, a pixel value of each pixel of the first stage class score image being a vector of size N representing first stage preliminary probabilities of a corresponding pixel in the input image belonging to the corresponding one of N classes; and
a second stage CNN, coupled to the first stage CNN, for receiving the first stage class score image and classifying each pixel of the first stage class score image among N classes, to generate a second stage class score image, the second stage class score image having a height and a width identical to those of the input image and having a depth equal to N, a pixel value of each pixel of the second stage class score image being a vector of size N representing second stage preliminary probabilities of a corresponding pixel in the input image belonging to the corresponding classes,
wherein each of the first stage CNN and the second stage CNN has a plurality of layers of neurons stacked sequentially, including at least a plurality of convolutional layers and a plurality of pooling layers, each convolutional layer performing convolution operations to convolve a number of filters across its previous layer, each pooling layer performing pooling operations on its previous layer.

2. The artificial neural network system of claim 1, which comprises only two CNNs and wherein the second stage preliminary probabilities are final probabilities of the corresponding pixel in the input image belonging to the corresponding classes.

3. The artificial neural network system of claim 1, further comprising a third stage CNN, coupled to the second stage CNN, for receiving the second stage class score image and classifying each pixel of the second stage class score image among N classes, to generate a final class score image, the final class score image having a height and a width identical to those of the input image and having a depth equal to N, a pixel value of each pixel of the final class score image being a vector of size N representing final probabilities of a corresponding pixel in the input image belonging to the corresponding classes.

4. The artificial neural network system of claim 1, wherein the first stage CNN and the second stage CNN have identical numbers and identical arrangements of the convolutional layers and the pooling layers, wherein the corresponding layers of the CNNs have identical sizes and the filters in corresponding convolutional layers of the CNNs have identical sizes.

5. The artificial neural network system of claim 1, wherein the first stage and second stage CNNs are independent of each other.

6. The artificial neural network system of claim 1, wherein the filters in all of the plurality of convolutional layers in the first stage and second stage CNNs have a height of 3 and a width of 3.

7. The artificial neural network system of claim 1, wherein N is equal to three, wherein the three classes include a background class, a foreground class and an edge class.

8. An image classification method using an artificial neural network system implemented on a computer, comprising:
providing a first stage convolutional neural network (CNN) and a second stage CNN, each of the first stage CNN and the second stage CNN having a plurality of layers of neurons stacked sequentially, including at least a plurality of convolutional layers and a plurality of pooling layers, each convolutional layer performing convolution operations to convolve a number of filters across its previous layer, each pooling layer performing pooling operations on its previous layer;
inputting an input image into the first stage CNN;
using the first stage CNN to classify each pixel of the input image among N classes, N being a natural number greater than or equal to two, to generate a first stage class score image, the first stage class score image having a height and a width identical to those of the input image and having a depth equal to N, a pixel value of each pixel of the first stage class score image being a vector of size N representing first stage preliminary probabilities of a corresponding pixel in the input image belonging to the corresponding one of N classes;
inputting the first stage class score image into the second stage CNN; and
using the second stage CNN to classify each pixel of the first stage class score image among N classes, to generate a second stage class score image, the second stage class score image having a height and a width identical to those of the input image and having a depth equal to N, a pixel value of each pixel of the second stage class score image being a vector of size N representing second stage preliminary probabilities of a corresponding pixel in the input image belonging to the corresponding classes.

9. The image classification method of claim 8, wherein the second stage preliminary probabilities are final probabilities of the corresponding pixel in the input image belonging to the corresponding classes.

10. The image classification method of claim 8, further comprising:
providing a third stage CNN, the third stage CNN having a plurality of layers of neurons stacked sequentially, including at least a plurality of convolutional layers and a plurality of pooling layers, each convolutional layer performing convolution operations to convolve a number of filters across its previous layer, each pooling layer performing pooling operations on its previous layer;
inputting the second stage class score image into the third stage CNN; and
using the third stage CNN to classify each pixel of the second stage class score image among N classes, to generate a final class score image, the final class score image having a height and a width identical to those of the input image and having a depth equal to N, a pixel value of each pixel of the final class score image being a vector of size N representing final probabilities of a corresponding pixel in the input image belonging to the corresponding classes.

11. The image classification method of claim 8, wherein the first stage CNN and the second stage CNN have identical numbers and identical arrangements of the convolutional layers and the pooling layers, wherein the corresponding layers of the CNNs have identical sizes and the filters in corresponding convolutional layers of the CNNs have identical sizes.

12. The image classification method of claim 8, wherein the first stage and second stage CNNs are independent of each other.

13. The image classification method of claim 8, wherein the filters in all of the plurality of convolutional layers in the first stage and second stage CNNs have a height of 3 and a width of 3.

14. The image classification method of claim 8, wherein N is equal to three, wherein the three classes include a background class, a foreground class and an edge class.

15. A method of training an artificial neural network system for image classification, the artificial neural network system being implemented on a computer and including a first stage convolutional neural network (CNN) and a second stage CNN, each of the first stage CNN and the second stage CNN having a plurality of layers of neurons stacked sequentially, including at least a plurality of convolutional layers and a plurality of pooling layers, each convolutional layer performing convolution operations to convolve a number of filters across its previous layer, each pooling layer performing pooling operations on its previous layer,
the training method comprising:
(a) training the first stage CNN using a first plurality of training images and first corresponding label data, wherein the label data corresponding to each of the first plurality of training image has a height and a weight equal to those of the corresponding training image and a pixel value of each pixel of the label data represents a desired classification result for a corresponding pixel of the corresponding training image, the desired classification being one of N classes, the training being conducted for M1 iterations to obtain a set of parameters for the first stage CNN;
(b) using the first stage CNN with the parameters obtained in step (a), performing forward propagation on each of a second plurality of training images, to generate a corresponding plurality of first stage class score images, each first stage class score image having a height and a width identical to those of the corresponding training image and having a depth equal to N, a pixel value of each pixel of the first stage class score image being a vector of size N representing first stage preliminary probabilities of a corresponding pixel in the corresponding training image belonging to the corresponding one of N classes;
(c) training the second stage CNN using the plurality of first stage class score images and second label data that correspond to the second plurality of training images, wherein the second label data corresponding to each of the second plurality of training image has a height and a weight equal to those of the corresponding training image and a pixel value of each pixel of the label data represents a desired classification result for a corresponding pixel of the corresponding training image, the desired classification being one of N classes, the training being conducted for M2 iterations to obtain a set of parameters for the second stage CNN.

16. The training method of claim 15, wherein M1 is less than M2.

17. The training method of claim 15, wherein the first stage CNN and the second stage CNN have identical numbers and identical arrangements of the convolutional layers and the pooling layers, wherein the corresponding layers of the CNNs have identical sizes and the filters in corresponding convolutional layers of the CNNs have identical sizes.

18. The training method of claim 15, wherein the first stage and second stage CNNs are independent of each other.

19. The training method of claim 15, wherein the filters in all of the plurality of convolutional layers in the first stage and second stage CNNs have a height of 3 and a width of 3.

20. The training method of claim 15, wherein N is equal to three, wherein the three classes include a background class, a foreground class and an edge class.
